(19) United States
(12) Patent Application Publication
(10) Pub. No.: US 2026/0057087 A1
(43) Pub. Date: Feb. 26, 2026

(54) Machine-readable medium, apparatus, computing system

(71) Applicant: Intel Corporation, Santa Clara, CA (US)

(72) Inventors: Krystian MATUSIEWICZ, Gdansk PM (PL); Mateusz BRONK, Gdansk (PL); Arkadiusz BERENT, Tuchom, Pomorskie (PL); Piotr ZMIJEWSKI, Gdansk PM (PL)

(21) Appl. No.: 19/251,907

(22) Filed: Jun. 27, 2025

(51) Int. Cl. G06F 21/60; G06F 21/64

(52) U.S. Cl. CPC G06F 21/604; G06F 21/64

(57) ABSTRACT

Provided is a non-transitory machine-readable medium comprising machine-readable instructions which, when the carried out on an apparatus, cause the apparatus to receive first data indicating a security policy for an application to be carried out on the apparatus. The instructions further cause the apparatus to instruct, based on the security policy, a security advisor to determine a security appraiser to enforce the security policy. The instructions further cause the apparatus to instruct, upon reception of second data indicating the determined security appraiser, the determined security appraiser to determine whether third data provided for enforcing the security policy is suitable to enforce the security policy.

### BACKGROUND

For assessing the quality of data, specialized algorithms or knowledge may be used. For example, random numbers used for cryptographic purposes may be used based on statistical or other specialized testing to assess the quality (randomness) of an incoming bitstring. Some weaknesses of random number generators may not be easily visible and using a specialized test case that directly checks against this weakness may be necessary. The quality of random numbers may be important with regard to the security of cryptographic entities or elements (such as keys, nonces, or the like).

### BRIEF DESCRIPTION OF THE FIGURES

Some examples of apparatuses and/or methods will be described in the following by way of example only, and with reference to the accompanying figures, in which

FIG. 1 depicts a block diagram of an apparatus according to the present disclosure;

FIG. 2 depicts a block diagram of a computing system according to the present disclosure;

FIG. 3 depicts a sequence diagram of a method according to the present disclosure;

FIG. 4 depicts an example of an interaction mode according to the present disclosure; and

FIG. 5 depicts a flowchart of a method according to the present disclosure.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A or B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

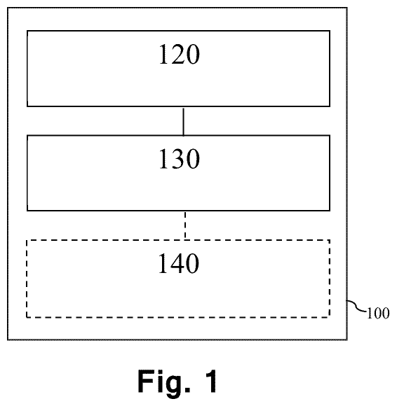

FIG. 1 illustrates a block diagram of an example of an apparatus 100 (or device 100). The apparatus 100 includes circuitry that is configured to provide the functionality of the apparatus 100. For example, the apparatus 100 of FIG. 1 includes interface circuitry 120, processing circuitry 130 and (optional) storage circuitry 140. For example, the processing circuitry 130 may be coupled with the interface circuitry 120 and optionally with the storage circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 140. Likewise, the device 100 may include means configured to provide the functionality of the device 100.

The components of the device 100 are defined as component means, which may correspond to, or implemented by, the respective structural components of the apparatus 100. For example, the device 100 of FIG. 1 includes means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may likewise be defined by one or more machine-readable instruction or a plurality of machine-readable instructions. The apparatus 100 or device 100 may include, implement, or carry out the machine-readable instructions, e.g., within the storage circuitry 140 or means for storing information 140.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may include circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may include a general-purpose processor, a Digital Signal Processor (DSP), a micro-controller, etc.

For example, the storage circuitry 140 or means for storing information 140 may include at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The apparatus 100 may be realized as a computer, such as a server or multiple servers, a computing device (such as a personal computer, a corporate computer, or the like), an internet of things (IoT) platform, or the like.

As indicated above, the processing circuitry may implement machine-readable instructions. Such machine-readable instructions may relate to non-transitory machine-readable instructions and may be stored on the storage circuitry 140, without limiting the present disclosure in that regard.

For example, the storage circuitry 140 may include or relate to a non-transitory machine-readable medium including machine-readable instructions which, when executed on the apparatus 100, cause the apparatus 100 (or the processing circuitry 130) to carry out the functions discussed herein.

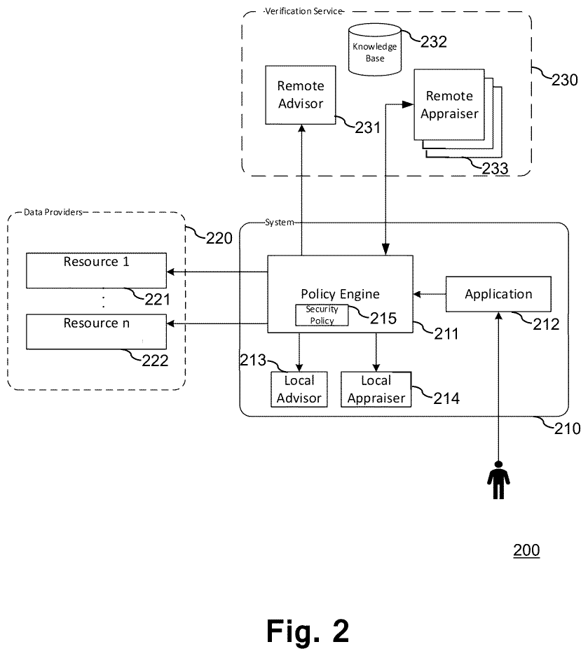

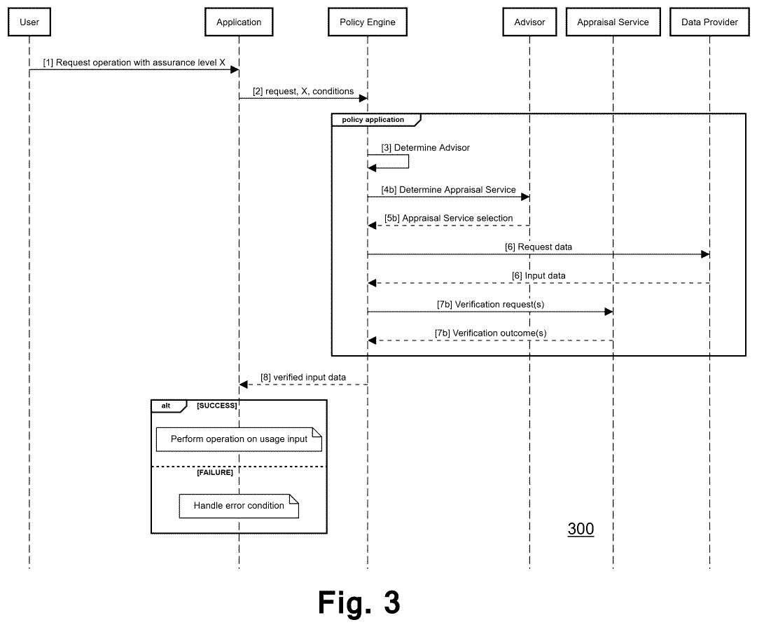

In the following, the functionality of the apparatus 100 are described under reference of a policy engine 211, as depicted in FIG. 2 which depicts a computing system 210, a plurality of data providers 220 and a verification service 230. It should be noted that apparatus 100 and policy engine 211 may be used interchangeably throughout the following description, but in some examples, the apparatus 100 may relate to the overall computing system 210. It will further be referred to FIG. 3 to describe a method according to the present disclosure.

The computing system 210 includes the policy engine 211, an application 212, a local security advisor 213, and a local security appraiser 214. Regarding the plurality of data providers 220, a first data provider (or Resource 1) 221, and a second data provider (or Resource n) 222 is depicted, but it should be understood that the present disclosure shall not be understood as limiting with respect to the number of data providers. The verification service 230 includes (or has access to at least one of) a remote advisor 231, a knowledge base 232, and a remote appraiser 233. Dashed lines in FIG. 2 indicate that the depicted entities (i.e., data providers 220 and verification service 230) are not necessarily a closed system, but rather symbolize a logic level of service entities.

The instructions cause the policy engine 211 to receive first data indicating a security policy 215 for the application 212 to be carried out on the computing system 210 (or apparatus 100). The application 212 may be any application for which a security policy 215 may be relevant, such as a confidential computing application, an encrypted communication application, or the like. Accordingly, the application 212 may explicitly communicate the security policy 215 or type of security policy 215 that is needed to fulfill security requirements, or the policy engine 211 may determine the security policy 215 based on data transmitted by the application 212 (e.g., based on the name or type of application, based on metadata, or the like).

For example, the security policy 215 may indicate a level of security that needs to be established for the application 212 to fulfill its security requirements. For example, the security policy 215 may indicate a minimum entropy of a random number that is needed for memory encryption to establish confidential computing. In such an example, the random number may be used to derive a cryptographic key (but it should be noted that memory encryption is only one example—in another example, secure communication may be established with the cryptographic key derived from random number (e.g., to derive a session key)). In another example, the security policy 215 may indicate a security level of a certificate (e.g., from a certificate authority) that is used for establishing trust. In such examples, the security level may be determined based on a combination of algorithms used in a certificate chain, security parameters of the corresponding algorithms and other information about the certificates (e.g. revocation status), or the like.

This process is depicted in FIG. 3 under reference of steps 1 and 2. At 1, a user may request an operation (that may be indicative of, e.g., key pair generation, certified key pair generation, or the like) from the application 212 with a desired assurance level X. For example, the user requests a cryptographic key pair generation with security level ‘High’.

At 2, the application 212 calls the policy engine 211 to determine an appropriate security strategy and passes on, as the first data, the expected security level X (as the security policy 215, in this example). In the example described above, the application 212 receives the request to generate the cryptographic key pair and it requests the policy engine 211 to determine an appropriate security advisor.

The instructions further cause the policy engine 211 to instruct, based on the security policy 215, a security advisor to determine a security appraiser to enforce the security policy 215.

A security advisor may relate to an apparatus or circuitry configured to determine, based on the security policy 215 or based on other data indicating the security level X transmitted from the policy engine 211, to determine an appropriate security appraiser.

On the other hand, a security appraiser may relate to an apparatus or circuitry configured to determine whether data provided for enforcing the security policy is actually suitable to enforce the security policy (e.g., whether a random number provided from any of the data providers 220 has a high enough entropy or is secure enough, as discussed above).

In other words, according to the present disclosure, the assessment whether and how the security policy 215 can be enforced may be divided between different entities: a security advisor and a security appraiser. The policy engine 211 may decide whether the local advisor 213 should be consulted or whether the remote advisor 231 should be consulted to determine an appropriate appraiser. The local advisor 213 may determine the local appraiser 214 as suitable, but in another example, the local advisor 213 may determine a remote appraiser 233 of a plurality of remote appraisers 233 as suitable. In another example, the local advisor 213 may determine that a remote advisor 231 should be consulted to determine an appropriate remote appraiser 233.

The process of determining an advisor is depicted in FIG. 3 under reference of step 3. The policy engine 211 decides whether to use the local advisor 213 or a remote advisor 231. The security policy may define selection criteria to decide which of the available advisors can be selected based on the security level and based on properties of data providers (e.g., based on the type of data that they provide, their position, their host, or the like. In the example mentioned above where the user requests a cryptographic key pair, the policy engine may determine that, for security level ‘High’, no local advisor 213 has the sufficient capabilities. It then determines that a remote advisor 231 service satisfies those requirements.

The instructions further cause the policy engine 211 to instruct, upon reception of second data (from the security advisor 213 or 231) indicating the determined security appraiser 214 or 233, the determined security appraiser 214 or 233 to determine whether third data provided (from at least one of the data providers 220) for enforcing the security policy 215 is suitable to enforce the security policy 215.

This process is depicted in FIG. 3 under reference of steps 4b to 7b. In this example, “b” indicates that the remote advisor 231 and remote appraiser 233 are selected, while “a” would indicate that the local advisor 213 and the local appraiser 214 are selected. Although this example is not depicted here, it should be noted that, in some examples, the instructions further cause the policy engine 211 to determine the security advisor based on the security policy and the determination of the security advisor includes determining whether the local security advisor 213 is suitable for determining the security appraiser 214 or 233.

Accordingly, if the local security advisor 213 is suitable for determining the security appraiser 214 or 233, the instructions further cause the policy engine 211 to instruct the local security advisor 213 to determine the security appraiser. However, if the local security advisor 213 is not suitable, the instructions may cause the policy engine 211 to determine a remote security advisor 231 and instruct the remote security advisor 231 to determine the security appraiser 214 or 233.

At 4b, the remote advisor 231 provides a decision to the policy engine 211 (as the second data) on which appraiser 233 should be used (there may be more than one appraiser 233 determined) to achieve the desired security assessment. The remote advisor 231 may use the knowledge base 232 as a database (tracking available appraisers 233 and their capabilities) and optionally input from other sensors (and/or external knowledge sources) to make the optimal decision on the security appraiser 233. Thereby, the advisor's 231 response may may change over time, even for the same input. This may allow to adjust the level of verification required responding to the current threat landscape. For example, less tests may be performed if the threat level is low or a completely new tests added as a response to a new threat vector. In the example mentioned above where the user requests a cryptographic key pair, the policy engine 211 requests the remote advisor 231 to select the suitable appraiser 233 that can be used for assessing the quality of cryptographic keys obtained from the data provider 220, and requests information about minimum properties of the data provider 220 that need to be satisfied.

In general terms, in some examples, the instructions further cause the policy engine 211 to receive the second data, and determine, based on the second data, whether the local security appraiser 214 is suitable for determining whether the third data are suitable to enforce the security policy 215.

In some examples, if the local security appraiser 214 is suitable for determining whether the third data is suitable to enforce the security policy 215, the instructions further cause the policy engine 211 to instruct the local security appraiser 214 to determine whether the third data are suitable to enforce the security policy 215. However, if the local appraiser 214 is not suitable, the instructions may cause the policy engine 211 to determine, based on the second data, a remote security appraiser 233, and instruct the remote security appraiser 233 to determine whether the third data are suitable to enforce the security policy 215.

At 5b, based on decision of the advisor 231, an appropriate appraiser 233 may be engaged, and the appraiser 233 may request input data (third data) it needs to perform the assessment. In the example mentioned above where the user requests a cryptographic key pair, the advisor 231 selects an appraiser 233 based on the requested task requirements, required capabilities of the appraiser 233, and based on the knowledge base 232 (e.g. database of known weaknesses in random number generators). The advisor 231 further selects a mode of interaction with the appraisal 233 and determines a suitable data provider 220. For example, the data provider might have the property of “True Random Number Generator” (TRNG—as opposed to e.g. deterministic pseudorandom number generator).

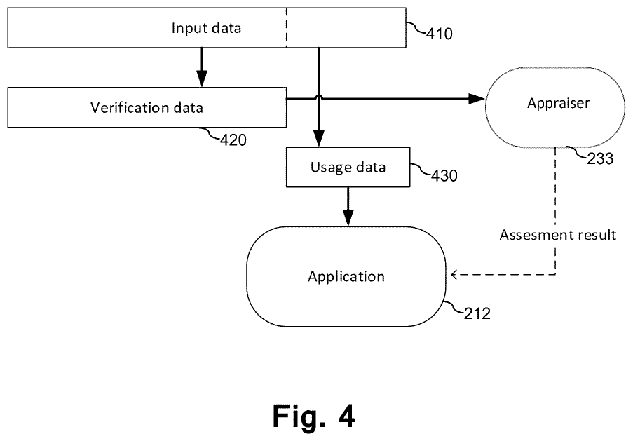

A proper mode of interaction may be “verify or use” which in the following, is briefly discussed under reference of FIG. 4, but it should be noted that there may be many modes of interaction with the suitable for different security levels and use cases.

In FIG. 4, input data (third data) 410 is shown that is split into verification data 420 and usage data 430 (that may be distinct from each other, in some examples). The verification data 420 are sent to the appraiser (such as the remote appraiser 233 or the local appraiser 214) to assess whether they conform to the required security level. It is assumed that, if the verification data 420 are suitable for the application 212, the usage data 430 are also suitable. In other words, FIG. 4 depicts a “verify or use” approach which relates to a probabilistic method to have some degree of verification of the input data 410 but the usage data 430 need to remain confidential and thus, cannot be directly shared with appraiser 233. Thus, input data 410 is split into two subsets. It should be noted that the splitting of the input data 410 into two parts is shown for exemplary purposes and the present disclosure is not limited in that regard as it might be split into more parts (parts may be overlapping, in some examples) and the splitting may depend on specific requirements of the use case. Using the “verify or use” approach, quality of the randomness may be assessed without losing confidentiality of the random number that is to be used for key generation

Another example of a mode of interaction may include a “spot checks”. In such a case, the requested input data is sent to the appraiser 233 based on a certain probability, i.e., the appraiser 233 might not called based on a distinct set of data, but the verification data may be at least a part of the usage data. This approach may be adopted when verification of all data is impractical or too costly, but the application 212 still needs to have some degree of trusted validation of the input data. For example, the data provider 220 may have signed a contractual agreement to provide input data with appropriate quality and the application 212 uses the appraiser 233 to ensure that the quality is adequate using a selected sample of the input data.

In general terms, in some examples, the third data include verification data 420 and usage data 430. In such an example, for instructing the remote security appraiser 233, the instructions may further cause the policy engine 212 to send the verification data 420 to the remote security appraiser 233. If the security appraiser 233 determines that the verification data are suitable to enforce the security policy 215, the instructions may further cause the policy engine 211 to enforce the security policy based on the usage data.

Returning to FIGS. 1 to 3, at 6b, based on the decision made by advisor 231 the appraiser 233, an appropriate data provider 220, and the input data (third data) requested by the appraiser 233 is fetched. In the example mentioned above where the cryptographic key pair is requested, after the selection of the appraiser 233 and the data provider 220, the application 212 may request sufficient input data (third data) from the selected data provider 220 that satisfies the property of being a TRNG and, according to the above-described “verify or use” strategy, splits the received data into two parts.

At 7b, the input data (third data) is then provided to the determined appraiser 233 that performs verification of the expected properties and returns the verification result. In the example mentioned above, where an cryptographic key pair is requested, the verification data 420 is sent to the appraiser 233. The appraiser 233 may run a predetermined set of statistical tests, such as NIST (National Institute of Standards and Technology) statistical tests (e.g., NIST SP800-22r1), and checks the verification data 420 against (known) vulnerabilities of random number generators documented in the knowledge base 232. For example, it might be relatively easy to determine if the bitstring comes from a linear generator like a Mersenne Twister. Such a check could prevent vulnerabilities as document in CVE2021-3692 or CVE2024-25389. If all tests pass, the appraiser 233 returns the positive assessment outcome to the policy engine 215.

At 8, the verified (third) data is returned to the application to perform the required operation. In the example mentioned above where a cryptographic key pair is requested, when the assessment outcome is positive, the application 212 uses the random number to derive the cryptographic key pair.

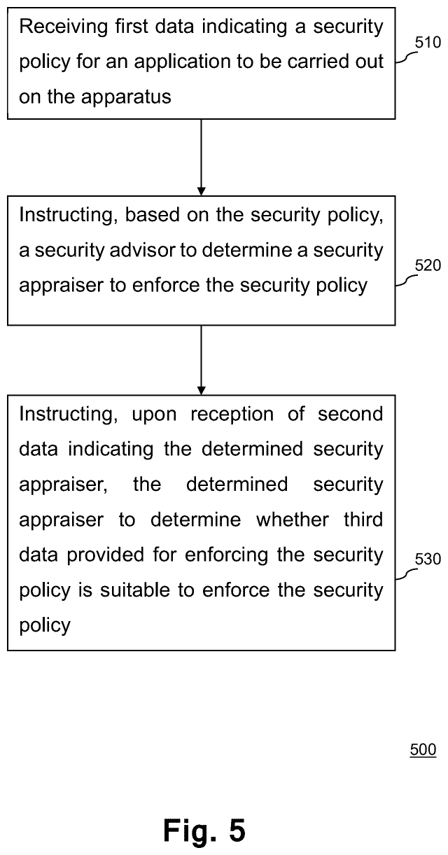

The aspects described above may likewise relate to a method 500 that is briefly discussed in the following under reference of FIG. 5.

The method 500 includes receiving, 510, first data indicating the security policy 215 for the application 212 to be carried out on the apparatus 211.

The method 500 further includes instructing, 520, based on the security policy 215, a security advisor 213 or 231 to determine a security appraiser 214 or 233 to enforce the security policy 215.

The method 500 further includes instructing, 530, upon reception of second data indicating the determined security appraiser 214 or 233, the determined security appraiser 214 or 233 to determine whether third data 410 provided for enforcing the security policy 215 is suitable to enforce the security policy 215.

In the following, some examples of the proposed technique are presented:

An example (e.g., example 1) relates to a non-transitory machine-readable medium including machine-readable instructions which, when the carried out on an apparatus, cause the apparatus to receive first data indicating a security policy for an application to be carried out on the apparatus. The instructions further cause the apparatus to instruct, based on the security policy, a security advisor to determine a security appraiser to enforce the security policy. The instructions further cause the apparatus to instruct, upon reception of second data indicating the determined security appraiser, the determined security appraiser to determine whether third data provided for enforcing the security policy is suitable to enforce the security policy.

Another example (e.g., example 2) relates to a previous example (e.g., example 1) or to any other example. In this example, the instructions further cause the apparatus to determine the security advisor based on the security policy. The determination of the security advisor includes determining whether a local security advisor is suitable for determining the security appraiser.

Another example (e.g., example 3) relates to a previous example (e.g., example 2) or to any other example. In this example, the instructions further cause the apparatus to, if the local security advisor is suitable for determining the security appraiser, instruct the local security advisor to determine the security appraiser, and, if not, determine a remote security advisor, and instruct the remote security advisor to determine the security appraiser.

Another example (e.g., example 4) relates to a previous example (e.g., any one of examples 1 to 3) or to any other example. In this example, the instructions further cause the apparatus to receive the second data, and determine, based on the second data, whether a local security appraiser is suitable for determining whether the third data are suitable to enforce the security policy.

Another example (e.g., example 5) relates to a previous example (e.g., example 4) or to any other example. In this example, the instructions further cause the apparatus to, if the local security appraiser is suitable for determining whether the third data is suitable to enforce the security policy, instruct the local security appraiser to determine whether the third data are suitable to enforce the security policy. If not, the instructions further cause the apparatus to determine, based on the second data, a remote security appraiser, and instruct the remote security appraiser to determine whether the third data is suitable to enforce the security policy.

Another example (e.g., example 6) relates to a previous example (e.g., example 5) or to any other example. In this example, wherein the third data include verification data and usage data. For instructing the remote security appraiser, the instructions further cause the apparatus to send the verification data to the remote security appraiser. In such an example, the instructions further cause the apparatus to, if the remote security appraiser determines that the verification data is suitable to enforce the security policy, enforce the security policy based on the usage data.

Another example (e.g., example 7) relates to a previous example (e.g., example 6) or to any other example. In this example, the verification data is distinct from the usage data.

Another example (e.g., example 8) relates to a previous example (e.g., example 6) or to any other example. In this example, the verification data is at least a part of the usage data.

Another example (e.g., example 9) relates to a previous example (e.g., any one of examples 1 to 8) or to any other example. In this example, the third data is at least one of an cryptograhic key and a verification key.

An example (e.g., example 10) relates to an apparatus including interface circuitry, machine-readable instructions, and processing circuitry to execute the machine-readable instructions to cause the apparatus to function in accordance with any one of examples 1 to 9.

An example (e.g., example 11) relates to a computing system including an apparatus according to example 10. The computing system further includes a local security advisor and a local security appraiser.

An example (e.g., example 12) relates to a method. The method includes receiving first data indicating a security policy for an application to be carried out on the apparatus. The method further includes instructing, based on the security policy, a security advisor to determine a security appraiser to enforce the security policy. The method further includes instructing, upon reception of second data indicating the determined security appraiser, the determined security appraiser to determine whether third data provided for enforcing the security policy is suitable to enforce the security policy.

Another example (e.g., example 13) relates to a previous example (e.g., example 12). In such an example, the method further includes determining the security advisor based on the security policy. The determination of the security advisor includes determining whether a local security advisor is suitable for determining the security appraiser.

Another example (e.g., example 14) relates to a previous example (e.g., example 12 or 13). In such an example, the method further includes if the local security advisor is suitable for determining the security appraiser, instructing the local security advisor to determine the security appraiser. If not, the method further includes determining a remote security advisor, and instruct the remote security advisor to determine the security appraiser.

Another example (e.g., example 15) relates to a previous example (e.g., any one of examples 12 to 14). In such an example, the method further includes receiving the second data. The method further includes determining, based on the second data, whether a local security appraiser is suitable for determining whether the third data is suitable to enforce the security policy.

Another example (e.g., example 16) relates to a previous example (e.g., example 15). In such an example, the method further includes, if the local security appraiser is suitable for determining whether the third data is suitable to enforce the security policy, instructing the local security appraiser to determine whether the third data is suitable to enforce the security policy. If not, the method further includes, determining, based on the second data, a remote security appraiser, and instruct the remote security appraiser to determine whether the third data is suitable to enforce the security policy.

Another example (e.g., example 17) relates to a previous example (e.g., example 16) in the case that a remote security appraiser is determined. In such an example, the third data include verification data and usage data. For instructing the remote security appraiser, the method further includes sending the verification data to the remote security appraiser. The method further includes, if the remote security appraiser determines that the verification data is suitable to enforce the security policy, enforcing the security policy based on the usage data.

Another example (e.g., example 18) relates to a previous example (e.g., example 17). In such an example, the verification data is distinct from the usage data.

Another example (e.g., example 19) relates to a previous example (e.g., example 17). In such an example, the verification data are at least a part of the usage data.

Another example (e.g., example 20) relates to a previous example (e.g., any one of examples 12 to 19). In such an example, the third data are at least one of an cryptographic key and a verification key.

An example (e.g., example 21) relates to a computer program including instructions which, when carried out on a computer or on an apparatus or on processing circuitry, cause the computer or apparatus or processing circuitry to carry out the method of any one of examples 12 to 20.

An example (e.g., example 22) relates to an apparatus including processing or only to processing circuitry configured to carry out the method of any one of examples 12 to 20.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A non-transitory machine-readable medium comprising machine-readable instructions which, when the carried out on an apparatus, cause the apparatus to:
receive first data indicating a security policy for an application to be carried out on the apparatus;
instruct, based on the security policy, a security advisor to determine a security appraiser to enforce the security policy; and
instruct, upon reception of second data indicating the determined security appraiser, the determined security appraiser to determine whether third data provided for enforcing the security policy is suitable to enforce the security policy.

2. The non-transitory machine-readable medium of claim 1, the instructions further causing the apparatus to:
determine the security advisor based on the security policy, the determination of the security advisor comprising determining whether a local security advisor is suitable for determining the security appraiser.

3. The non-transitory machine-readable medium of claim 2, the instructions further causing the apparatus to:
if the local security advisor is suitable for determining the security appraiser, instruct the local security advisor to determine the security appraiser; and
if not, determine a remote security advisor, and instruct the remote security advisor to determine the security appraiser.

4. The non-transitory machine-readable medium of claim 1, the instructions further causing the apparatus to:
receive the second data; and
determine, based on the second data, whether a local security appraiser is suitable for determining whether the third data are suitable to enforce the security policy.

5. The non-transitory machine-readable medium of claim 4, the instructions further causing the apparatus to:
if the local security appraiser is suitable for determining whether the third data is suitable to enforce the security policy, instruct the local security appraiser to determine whether the third data are suitable to enforce the security policy; and
if not, determine, based on the second data, a remote security appraiser, and instruct the remote security appraiser to determine whether the third data is suitable to enforce the security policy.

6. The non-transitory machine-readable medium of claim 5, in the case that a remote security appraiser is determined,
wherein the third data comprise verification data and usage data,
and wherein, for instructing the remote security appraiser,
the instructions further causing the apparatus to:
send the verification data to the remote security appraiser; and
if the remote security appraiser determines that the verification data is suitable to enforce the security policy, enforce the security policy based on the usage data.

7. The non-transitory machine-readable medium of claim 6, wherein the verification data is distinct from the usage data.

8. The non-transitory machine-readable medium of claim 6, wherein the verification data is at least a part of the usage data.

9. The non-transitory machine-readable medium of claim 1, wherein the third data is at least one of an cryptographic key and a verification key.

10. An apparatus comprising processing circuitry, the processing circuitry being configured to:
receive first data indicating a security policy for an application to be carried out on the apparatus;
instruct, based on the security policy, a security advisor to determine a security appraiser to enforce the security policy; and
instruct, upon reception of second data indicating the determined security appraiser, the determined security appraiser to determine whether third data provided for enforcing the security policy is suitable to enforce the security policy.

11. The apparatus of claim 10, the processing circuitry being further configured to:
determine the security advisor based on the security policy, the determination of the security advisor comprising determining whether a local security advisor is suitable for determining the security appraiser.

12. The apparatus of claim 11, the processing circuitry being further configured to:
if the local security advisor is suitable for determining the security appraiser, instruct the local security advisor to determine the security appraiser; and
if not, determine a remote security advisor, and instruct the remote security advisor to determine the security appraiser.

13. The apparatus of claim 10, the processing circuitry being further configured to:
receive the second data; and
determine, based on the second data, whether a local security appraiser is suitable for determining whether the third data is suitable to enforce the security policy.

14. The apparatus of claim 13, the processing circuitry being further configured to:
if the local security appraiser is suitable for determining whether the third data is suitable to enforce the security policy, instruct the local security appraiser to determine whether the third data is suitable to enforce the security policy; and
if not, determine, based on the second data, a remote security appraiser, and instruct the remote security appraiser to determine whether the third data is suitable to enforce the security policy.

15. The apparatus of claim 14, in the case that a remote security appraiser is determined,
wherein the third data comprise verification data and usage data,
and wherein, for instructing the remote security appraiser,
the processing circuitry being further configured to:
send the verification data to the remote security appraiser; and
if the remote security appraiser determines that the verification data is suitable to enforce the security policy, enforce the security policy based on the usage data.

16. The apparatus of claim 15, wherein the verification data is distinct from the usage data.

17. The apparatus of claim 16, wherein the verification data is at least a part of the usage data.

18. The apparatus of claim 10, wherein the third data is at least one of a cryptographic key and a verification key.

19. A computing system comprising an apparatus according to claim 10;
a local security advisor; and
a local security appraiser.
